(19) United States
(12) Patent Application Publication
(10) Pub. No.: US 2016/0034190 A1
(43) Pub. Date: Feb. 4, 2016

(54) Method for scheduling operation of a solid state disk

(71) Applicant: Quanta Storage Inc., Taoyuan City (TW)

(72) Inventors: Cheng-Yi Lin, Taoyuan City (TW); Yi-Long Hsiao, Taoyuan City (TW)

(21) Appl. No.: 14/667,711

(22) Filed: Mar. 25, 2015

(30) Foreign Application Priority Data
Jul. 29, 2014 (CN) 201410365857.3

(51) Int. Cl. G06F 3/06; G06F 9/48; G06F 12/08

(52) U.S. Cl. CPC G06F 3/061; G06F 3/0659; G06F 3/0685; G06F 12/0875; G06F 9/4881; G06F 2212/2022; G06F 2212/1016; G06F 2212/452

(57) ABSTRACT

A method for scheduling operations of a solid state disk includes receiving accessing operations from a host, temporarily storing the accessing operations, setting a higher priority to the accessing operations having a shorter operation time, rearranging sequence of the accessing operations according to the set priorities, distributing the accessing operations to corresponding flash memories to process data according to the accessing operations, and transmitting processed data to the host to increase efficiency of the accessing operations.

### BACKGROUND OF THE INVENTION

1. Field of the Invention

The present invention presents a method for scheduling operations of a solid state disk, and more particularly, a method for scheduling operations of a solid state disk by processing accessing operations from a host and rearranging a sequence of the accessing operations in each flash memory.

2. Description of the Prior Art

A solid state drive (SSD) conventionally has a number of NAND flash memories combined to form a storage device. The solid state drive has a fixed structure making it suitable to be carried around making transfer of data fast. Thus, the solid state drive is a popular product for transferring large amounts of data.

FIG. 1 illustrates a flowchart of a method for scheduling operations of a solid state disk according to prior art. For the prior art, a host 10 transmits accessing operations. The solid state disk receives the accessing operations and temporarily stores the accessing operations in a cache memory 12. A controller 11 of the solid state disk can then transmit the accessing operations in a sequence that the accessing operations are received to corresponding flash memories 14 through first in first out (FIFO) pipelines 13a corresponding to the flash memories 14. The flash memories 14 execute the accessing operations according to the sequence of the accessing operations. The stored data in the flash memories 14 are processed according to the accessing operations. The first in first out (FIFO) pipelines 13a are then used to transmit the processed data to the host 10. Thus, the flash memories 14 each having a corresponding first in first out pipeline can simultaneously perform accessing operation to increase the efficiency of performing the accessing operations.

But, when performing of an accessing operation generates a delay due to the limitation of the first in first out pipeline, accessing operations yet to be performed need to wait and the processing in the host is also delayed. Furthermore, the solid state disk of the prior art randomly allocates data to different flash memories. Although some of the flash memories have already transmitted the processed data to the host, the host still needs to wait for the processed data of the flash memories delayed for the host to perform processing. A decrease in the efficiency of the host occurs and the solid state disk loses the ability to transfer data at high speed. Thus, there are problems with the method for scheduling operation of the solid state disk that needs to be solved.

### SUMMARY OF THE INVENTION

An objective of the present invention is to present a method for scheduling operations of a solid state disk. According to type, a higher priority is set to accessing operations having a shorter operation time and sequence of the accessing operations is rearranged to increase efficiency of the accessing operations.

To achieve the objective of the present invention, the method for scheduling operations of a solid state disk includes receiving accessing operations from a host, temporarily storing the accessing operations, setting a higher priority to the accessing operations having a shorter operation time, rearranging sequence of the accessing operations, distributing the accessing operations to corresponding flash memories to process data according to the accessing operations, and transmitting processed data of to the host.

Another objective of the present invention is to present a method for scheduling operations of a solid state disk. Each of the flash memories concurrently performs similar accessing operations to decrease waiting time of a host and increase operation speed of the host.

To achieve the objective of the present invention, the method for scheduling operations of the solid state disk includes receiving accessing operations from a host. The accessing operations are temporarily stored in a cache memory of the solid state disk. According to sequence of the accessing operations including a read operation, a modify operation, a write operation, and an erase operation going from shortest operation time to longest operation time, sequence of the accessing operations are rearranged. The accessing operations are distributed to corresponding flash memories using first in first out pipelines. Each of the flash memories concurrently performs similar accessing operations. The processed data are transmitted to the host using first in first out pipelines.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a method for scheduling operations of a solid state disk according to prior art.

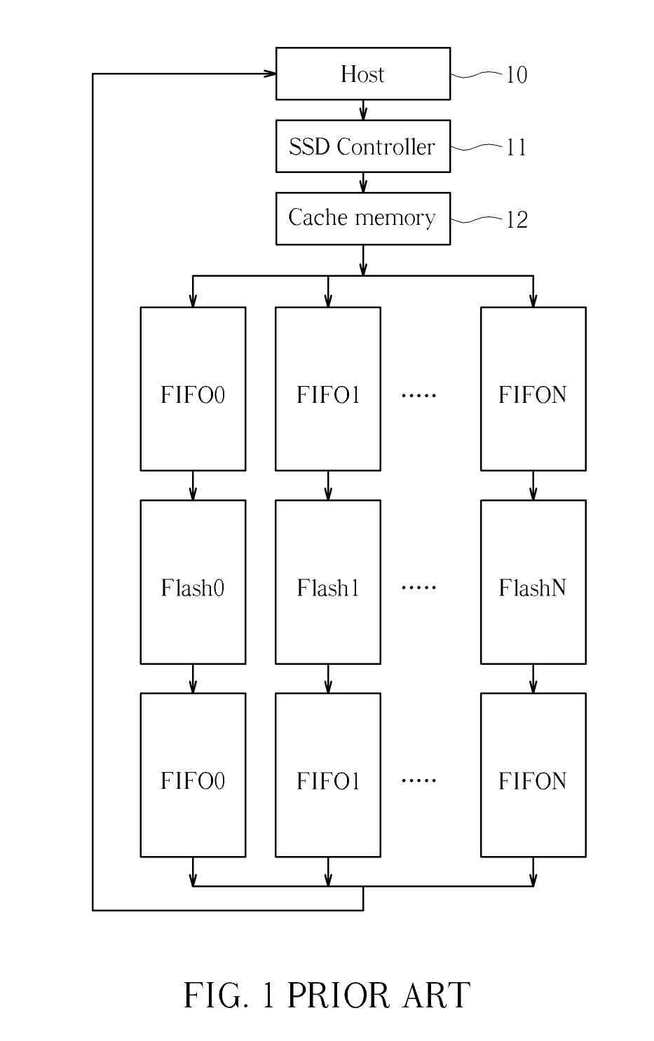

FIG. 2 illustrates a structure of a solid state disk according to an embodiment of the present invention.

FIG. 3 illustrates a comparison diagram of accessing operations in different sequences according to an embodiment of the present invention.

FIG. 4 illustrates a diagram of a sequence of accessing operations in a solid state disk according to an embodiment of the present invention.

FIG. 5 illustrates a flowchart of a method of arranging a sequence of accessing operations of a solid state disk according to an embodiment of the present invention.

### DETAILED DESCRIPTION

To achieve the objective of the present invention, preferred embodiments of the present invention are described in the following paragraphs together with some illustrations.

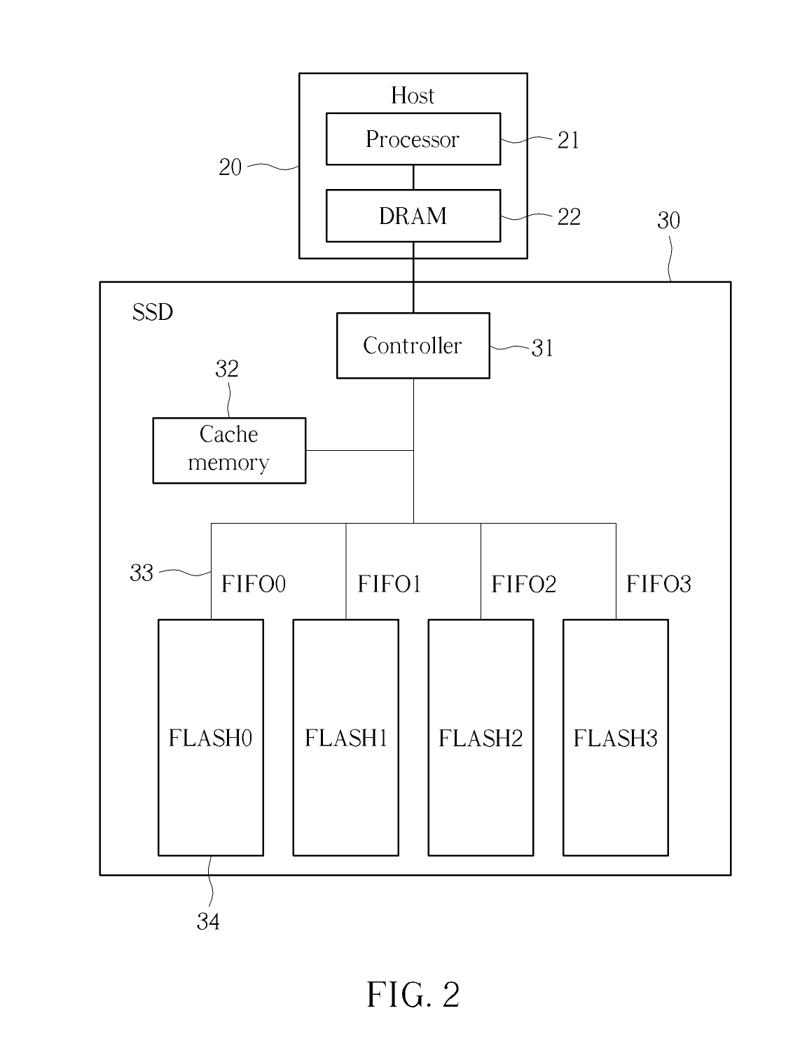

FIG. 2 illustrates a structure of a solid state disk 30 according to an embodiment of the present invention. FIG. 2 also illustrates a host 20. The host 20 may comprise a processor 21 configured to transmit accessing operations and a dynamic random-access memory (DRAM) 22 configured to temporarily store data of the accessing operations. The solid state disk 30 of the present invention may be connected to the host 20. The solid state disk 30 may comprise a controller 30, a cache memory 32, a plurality of first in first out (FIFO) pipelines 33, and a plurality of flash memories 34. The controller 30 in coordination with a cache memory 32 may be configured to control the plurality of flash memories 34. The plurality of first in first out pipelines 33 may have a one to one correspondence with the plurality of flash memories 34. The above described configuration may form a storage device used by the host 20 to store data. Although the embodiment of the solid state disk 30 only has four flash memories FLASH0 to FLASH3, the present invention is not limited to only having four flash memories. The size of the solid state disk 30 may vary depending on the number of the plurality of flash memories 34 of the solid state disk 30 needed.

The controller 31 of the solid state disk 30 may receive accessing operations from the host 20 and temporarily store the accessing operations in the cache memory 32. The accessing operations may each be assigned to a corresponding flash memory 34 for processing. The accessing operations may be distributed to corresponding flash memories 34 through the plurality of first in first out pipelines 33. Each of the flash memories 34 may perform the accessing operations according to the sequence of the accessing operations. A flash memory 34 may have a data area and a spare area. Each of the data area and the spare area may comprise of a plurality of blocks. Each of the plurality of blocks may comprise a plurality of physical pages. The data may be deleted from the flash memory 34 by block. When the flash memory 34 is performing an accessing operation, the block of the data area may be used to read (R) data of the physical page. A first in first out pipeline 33 may be used to send the data to the dynamic random-access memory 22 and reserved for the use of the host 20. After the host 20 has modified (M) the data, the solid state disk 30 may select a block of the spare area and write (W) the modified data to a physical page of the block of the spare area to form new block of the data area and a mapping table may be updated. The original data stored in a physical page of a block of the data area may be erased (E) from the block of the data area and recycled to form a new block of the spare area. Therefore, the host 20 may transmit accessing operations to the solid state disk 30 and, according to a command, the solid state disk 30 performs a read (R) operation, a modify (M) operation, a write (W) operation, and an erase (E) operation in the plurality of flash memories 34.

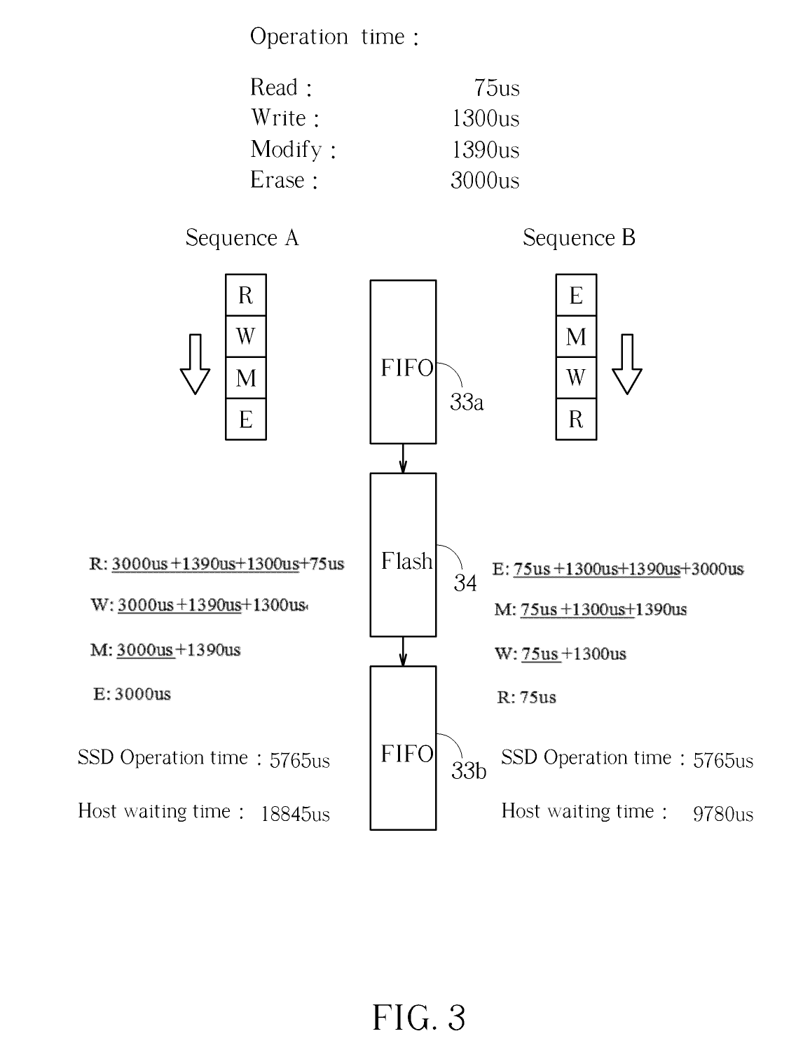

FIG. 3 illustrates a comparison diagram of accessing operations in different sequences according to an embodiment of the present invention. The operation time of the read (R) operation, the modify (M) operation, the write (W) operation, and the erase (E) operation may be compared to one another. The read operation may typically read data of a plurality of physical pages. Thus, the read operation may have the shortest operation time (approximately 75 us). The write operation may need to change the format of the data and allocate the data to a corresponding flash memory 34. Thus, the write operation may have a longer operation time (approximately 1300 us) than the read operation. Because the modify operation may include reading, modifying and writing of data, the operation time may approximately be 1390 us. The erase operation may need to erase all of the data in a block of the data area. Thus, the erase operation may have the longest operation time (approximately 3000 us). Data relevant to the solid state disk 30 may be stored and distributed to the plurality of flash memories 34. The host 20 may need to wait for the plurality of flash memories 34 to read all relevant data to be able to start the processing of the relevant data. The length of the waiting time may affect the efficiency of the host 20. Thus, to prevent a prolonged operation time caused by the blocking of the preceding operation due in first in first out pipelines, the present invention may rearrange the sequence of the accessing operations. Accessing operation having shorter operation time may have a higher priority to reduce the waiting time of the host.

For example, the solid state disk may receive accessing operations corresponding to a flash memory from the host in a sequence A in an order of an erase (E) operation, a modify (M) operation, a write (W) operation, and a read (R) operation. The sequence A of the present invention may be rearranged to have accessing operations with shortest operation time performed first to form sequence B in an order of a read (R) operation, a write (W) operation, a modify (M) operation, and an erase (E) operation. The waiting time of the host for the two sequences may be calculated and compared. When performing the accessing operations in the sequence A, the accessing operations in the sequence A may be delivered to a flash memory 34 through a first in first out pipeline 33a of the plurality of first in first out pipelines 33. According to the sequence A, the flash memory 34 may first perform the erase operation. A first in first out pipeline 33b of the plurality of first in first out pipelines 33 may be used to deliver a notification to the host of finishing the erase operation after an operation time of 3000 us. The waiting time for the host to receive processed data after performing the erase operation may be 3000 us. The modify operation may be performed next. Aside from the 1390 us needed to perform the modify operation, due to the limitation of the plurality of first in first out pipelines 33, the operation time of 3000 us of the erase operation may be added to the waiting time of the host. As shown in FIG. 3, the waiting time of the host may be 3000 us+1390 us=4390 us before the host receives processed data after performing the modify operation. The same for the write operation, aside from the 1300 us needed to perform the write operation, due to the limitation of the plurality of first in first out pipelines 33, the operation time of 3000 us of the erase operation and the operation time of 1390 us of the modify operation may be added to the waiting time of the host. The waiting time of the host may be 3000 us+1390 us+1300 us=5690 us before the host receives processed data after performing the write operation. The same for the read operation, aside from the 75 us needed to perform the write operation, due to the limitation of the plurality of first in first out pipelines 33, the operation time of 3000 us of the erase operation, the operation time of 1390 us of the modify operation, and the operation time of 1300 of the write operation may be added to the waiting time of the host. The waiting time of the host may be 3000 us+1390 us+1300 us+75 us=5765 us before the host receives processed data after performing the write operation. To finish the performing of the accessing operations in the sequence A, the operation time of the solid state disk 30 may be 3000 us+1390 us+1300 us+75 us=5765 us and the total waiting time of the host may be 3000 us+4390 us+5690 us+5765 us=18845 us.

When performing the accessing operations in the sequence B, the accessing operations in the sequence B maybe delivered to a flash memory 34. According to the sequence B, the flash memory 34 may first perform the read operation. A first in first out pipeline 33b of the plurality of first in first out pipelines 33 may be used to deliver a notification to the host of finishing the read operation after an operation time of 75 us. The waiting time for the host to receive processed data after performing the read operation may be 75 us. The same for the write operation, aside from the 1300 us needed to perform the write operation, the operation time of 75 us of the read operation may be added to the waiting time of the host. The waiting time of the host maybe 75 us+1300 us=1375 us before the host receives processed data after performing the write operation. When performing the modify operation, aside from the 1390 us needed to perform the modify operation, the operation time of the read operation and the write operation may be added to the waiting time of the host. The waiting time of the host may be 75 us+1300 us+1390 us=2765 us before the host receives processed data after performing the modify operation. When performing the erase operation, aside from the 3000 us needed to perform the erase operation, the operation time of the read operation, the write operation, and the erase operation may be added to the waiting time of the host. The waiting time of the host may be 75 us+1300 us+1390 us+3000=5765 us before the host receives processed data after performing the erase operation. To finish the performing of the accessing operations in the sequence B, the operation time of the solid state disk 30 may be 3000 us+1390 us+1300 us+75 us=5765 us and the total waiting time of the host may be 75 us+1375 us+2765 us+5765 us=9780 us. Although the operation time of the solid state disk 30 for sequence A and sequence B maybe 5765 us, but, by rearranging the sequence of accessing operations in sequence B, the waiting time of the host may be 9780. As compared to the waiting time of 18845 of the host in sequence A, the waiting time of the host may be reduced to at least half and, thus, greatly increasing the efficiency of the host.

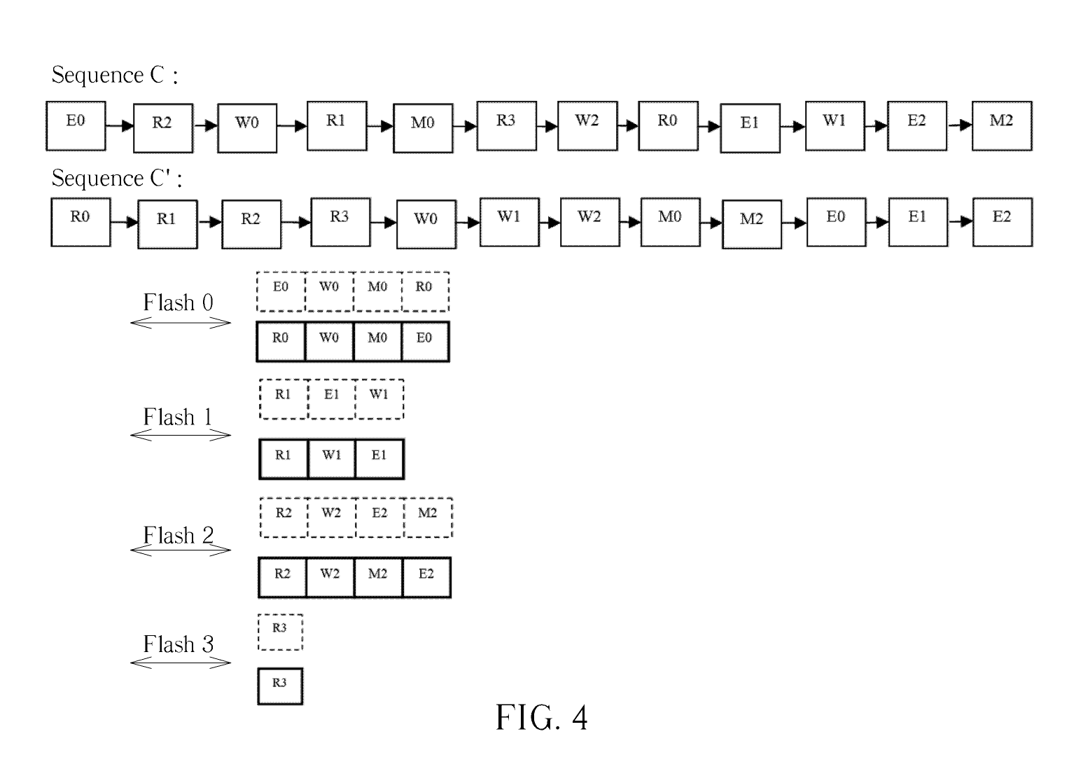

FIG. 4 illustrates a diagram of a sequence of accessing operations in a solid state disk according to an embodiment of the present invention. For example, the solid state disk may receive accessing operations from the host in sequence C. The sequence C may be E0-R2-M0-R1-W0-R3-W2-R0-E1-W1-E2-M2. The number following the accessing operation symbol may represent the corresponding flash memory of the accessing operation. The accessing operations may be sent to the flash memories FLASH0 to FLASH3 by the solid state disk in the sequence enclosed in dashed outline as shown in FIG. 4. The flash memories FLASH1 to FLASH3 may have to perform the accessing operations with shortest operation time, the read operations R1-R2-R3. Process data corresponding to the read operations R1-R2-R3 may be transmitted to the host. The host may also have to wait for the flash memory FLASH0 to perform accessing operations with longer operation time, the accessing operations E0-M0-WO, before being able perform read operation RO and receive processed data after performing the read operations. Thus, a delay before the host can process read data may occur. The same may happen when performing preceding accessing operations W0-W02 . The accessing operation El may cause a wait before being able to perform the accessing operation W1 . And for performing the accessing operation MO, the accessing operation E2 may cause a wait before being able to perform the accessing operation M2. Thus, a delay on the host to process data may occur.

After rearranging the accessing operations in sequence C to have accessing operations with shortest operation time performed first to form sequence C′ in an order of a read (R) operation, a modify (M) operation, a write (W) operation, and an erase (E) operation. The sequence C′ may be R0-R1-R2-R3-W0-W1-W2-M0-M2-E0-E1-E2. The accessing operations may be sent to the flash memories FLASH0 to FLASH3 by the solid state disk in the sequence enclosed in solid outline as shown in FIG. 4. First, the read operations R0-R1-R2-R3 may be performed concurrently in the flash memories FLASH0 to FLASH3 and then the read data may be transmitted to the host. The host may have a waiting time of 75 us before finishing the processing of read data, which is equivalent to the operation time of the read operation. In the same way, the write operations W0-W1-W2 may be performed concurrently in the flash memories FLASH0 to FLASH2. The host may have a waiting time of 1300 us before finishing the processing of write data, which is equivalent to the operation time of the write operation. The modify operations M0-M2 may be performed concurrently in the flash memories FLASH0 and FLASH2. The host may have a waiting time of 1390 us before finishing the processing of modify data, which is equivalent to the operation time of the modify operation. The erase operations E0-E1-E2 may be performed concurrently in the flash memories FLASH0 to FLASH2. The host may have a waiting time of 3000 us before finishing the processing of erase data, which is equivalent to the operation time of the erase operation. Thus, the efficiency of executing the accessing operations may be increased.

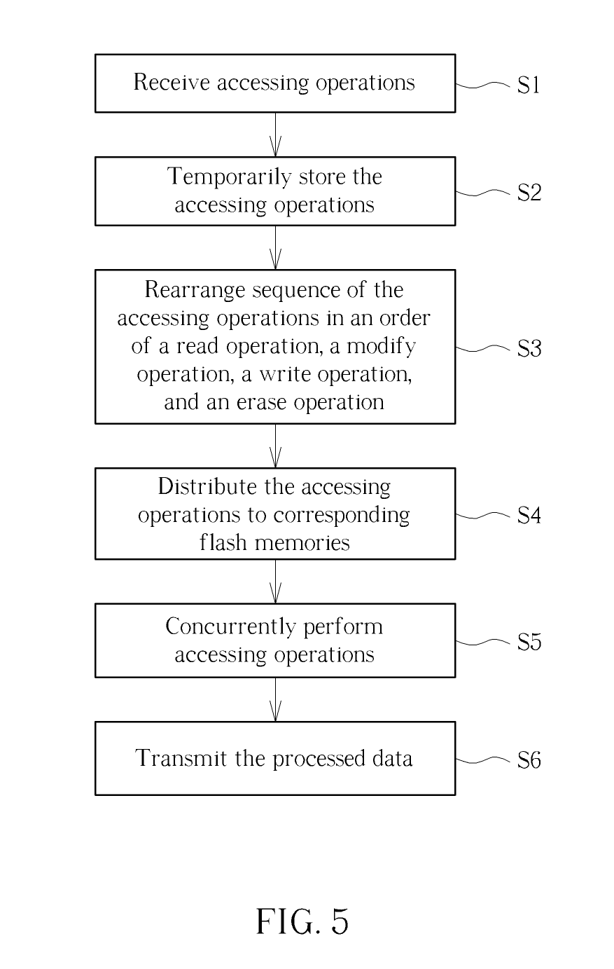

FIG. 5 illustrates a flowchart of a method of arranging a sequence of accessing operations of a solid state disk according to an embodiment of the present invention. The method of arranging the sequence of the accessing operations of the solid state disk may include but is not limited to the following steps:

Step S1: receive accessing operations from a host;

Step S2: temporarily store the accessing operations in a cache memory;

Step S3: set a higher priority to the accessing operations having a shorter operation time; according to the order of operation time of a read (R) operation, a modify (M) operation, a write (W) operation, and an erase (E) operation, rearranging sequence of the accessing operations;

Step S4: distribute the accessing operations to corresponding flash memories using a plurality of first in first out pipelines;

Step S5: each of the flash memories concurrently perform similar accessing operations;

Step S6: transmit the processed data to the host using a plurality of first in first out pipelines.

According to the disclosed steps, the method of arranging the sequence of the accessing operations of the solid state disk of the present invention may rearrange the sequence of the accessing operations in the flash memory according to the operation time of the accessing operation. Accessing operations having a shorter operation time may be set to have higher priority. The plurality of first in first out pipelines may be used to distribute the accessing operations to corresponding flash memory. The flash memories concurrently perform similar accessing operations. Thus, the waiting time of the host is reduced and the efficiency of executing accessing operations is increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for scheduling operations of a solid state disk, comprising:
receiving accessing operations from a host;
temporarily storing the accessing operations;
setting a higher priority to the accessing operations having a shorter operation time, and rearranging sequence of the accessing operations;
distributing the accessing operations to corresponding flash memories to process data according to the accessing operations; and
transmitting processed data to the host.

2. The method of claim 1, wherein temporarily storing the accessing operation is temporarily storing the accessing operation in a cache memory of the solid state disk.

3. The method of claim 1, wherein the sequence of the accessing operations from an accessing operation having shortest operation time to an accessing operation having longest operation time is respectively a read operation, a modify operation, a write operation, and an erase operation.

4. The method of claim 1, wherein the accessing operations are distributed to corresponding flash memories using a plurality of first in first out pipelines.

5. The method of claim 1, wherein each of the flash memories concurrently perform similar accessing operations.

6. The method of claim 1, wherein the processed data are transmitted to the host using a plurality of first in first out pipelines.
